(19) United States
(12) Patent Application Publication
(10) Pub. No.: US 2020/0173359 A1
(43) Pub. Date: Jun. 4, 2020

(54) FLAME RETARDANT INSULATION FOR INTERNAL COMBUSTION ENGINES

(71) Applicant: Covestro Deutschland AG, Lever-kusen (DE)

(72) Inventor: Joern Beaujean, Bergisch Gladbach (DE)

(21) Appl. No.: 16/628,362

(22) PCT Filed: Jul. 2, 2018
(86) PCT No.: PCT/EP2018/067788

§ 371 Date: Jan. 3, 2020

(30) Foreign Application Priority Data
Jul. 7, 2017 (EP) 17180191.3
Jun. 25, 2018 (EP) 18179609.5

(51) Int. Cl. F02B 77/13; C08G 18/48; C08G 18/76; C08G 18/40

(52) U.S. Cl. CPC F02B 77/13; C08G 18/4816; C08G 2101/0058; C08G 18/7664; C08G 18/409; C08G 18/4845

(57) ABSTRACT

The invention relates to a process for producing polyurethane foam for the thermal and acoustic insulation of engines, wherein the polyurethane foam is obtained or is obtainable by reaction of diisocyanates and/or polyisocyanates with filler-containing polyols, where the filler is preferably a reaction product of diisocyanates and/or polyisocyanates with compounds having hydrogen atoms which are reactive toward isocyanates, in the presence of water and/or physical blowing agents. The invention further relates to the use of the polyurethane foam for thermal and acoustic insulation for internal combustion engines, and also thermal and acoustic insulation for internal combustion engines containing the polyurethane foam.

The invention relates to a process for producing polyurethane foam for the thermal and acoustic insulation of engines, wherein the polyurethane foam is obtainable or is obtained by reaction of diisocyanates and/or polyisocyanates with filler-containing polyols, where the filler is preferably a reaction product of diisocyanates and/or polyisocyanates with compounds having hydrogen atoms which are reactive toward isocyanates, in the presence of water and/or physical blowing agents. The invention further relates to the use of the polyurethane foam for thermal and acoustic insulation for internal combustion engines and also thermal and acoustic insulation for internal combustion engines containing the polyurethane foam.

Thermal insulation of internal combustion engines reduces the heating-up phase of the still-cold engine after starting and thus helps the wear of the engine, and also reduces the increased fuel consumption and the associated greater emission of pollutants. Insulation of internal combustion engines can, simultaneously, also serve for acoustic insulation. In order to ensure very good acoustic insulation, complete encapsulation of the engine housing has been proposed in the prior art. Polyurethane foams have been described quite generally as material for the insulation. However, in respect of the mechanical and thermal stresses to which components in the engine compartment are subjected, it is desirable for the polyurethane foams used in the engine compartment to have a foam density in the range from 130 to 200 kg/m³.

Internal combustion engines become very hot. It is therefore important for the material of which the insulation consists to catch fire only with difficulty. In addition, materials which are used in vehicle construction have to be flame-retardant. The flame-retardant properties of materials are examined by means of various test methods which reflect the particular aspects of the respective field of use. The flame-retardant properties of materials for furniture and upholstery are examined in accordance with the fire protection standard Crib V or what is known as the paper cushion test. Materials which are used in vehicle construction have to satisfy the requirements of FMVSS 302 (Federal Motor Vehicle Safety Standards). The standard requires the horizontal burning speed not to exceed 0 mm/min. In order to satisfy this criterion, the foam has to extinguish spontaneously before reaching the first measurement mark at 25 mm. A further criterion is that the drops formed during melting do not burn. This behavior is referred to as non-burning dripping. This prevents the further spread of the possible seat of fire in the engine compartment.

In order to improve the burning behavior of polyurethane foams, flame retardants or additives are usually employed. However, such flame retardants or additives can change the mechanical properties of a polyurethane foam or lead to undesirable emissions. In addition, any additive is associated with additional costs. There is therefore a need for flame-retardant materials, in particular polyurethane foams, for the thermal and acoustic insulation of engines. In addition, there is a need for flame-retardant polyurethane foams which do not contain any flame retardants or flame-retardant additives. For use in the engine compartment, there is, in particular, a need for polyurethane foams which, while being held horizontally, do not exceed a burning speed of 0 mm/min while burning and do not reach the mark of 25 mm, and also do not form any burning drops which fall down during combustion.

WO 2014/195153 relates to a thermally insulated internal combustion engine, wherein the insulation consists of a polyurethane foam. Although the document says that the polyurethane foams used have to have a high thermal stability, it does not disclose any flame-retardant effect of the polyurethane foams.

DE 19962911 relates to flame-resistant molded high-resilience polyurethane foams having reduced smoke intensity and toxicity. The document discloses polyurethane foams which are obtained by reaction of filled polyols, with the polyurethane foams obtained having foam densities of 55 kg/m³. The document relates first and foremost to polyurethane foams for upholstery, interior cladding and furniture.

WO 2011/003590 discloses a process for producing flame-retardant flexible polyurethane foams. The flexible polyurethane foam contains filled polyols and also red phosphorus as flame retardants. The flexible polyurethane foams disclosed in this document have a foam density in the range of 35-38 kg/m³.

US 2016/0145377 relates to flame-retardant polyurethane foams which can be used in the engine compartment of an automobile. The polyurethane foams of this document each contain two different filled polyols, namely a styrene-acrylonitrile-filled polyol and a polyol which is filled with polyurea dispersion. The polyurethane foams have a density of 112-123 kg/m³.

It was therefore an object of the present invention to provide a process for producing polyurethane foam for the thermal and acoustic insulation of engines which has good flame-retardant properties. In particular, the flame retardancy requirements of FMVSS302 should be satisfied. In particular, it was an object to provide a process for producing a polyurethane foam which, in a horizontal position during combustion, does not exceed a burning speed of 0 mm/min and does not reach a mark of 25 mm, and also does not form any burning drops which fall down during combustion. In addition, the flame-retardant properties should be achieved without addition of flame retardants or flame-retardant additives.

This object is achieved by a process for producing polyurethane foam for the thermal and acoustic insulation of engines, wherein the polyurethane foam is obtained or is obtainable by reaction of a composition containing or consisting of
a component A1 containing or consisting of at least one filled polyol,
a component A2 containing or consisting of compounds which are reactive toward isocyanates and have a number average molecular weight of from 400 to 18000 g/mol,
optionally a component A3 containing or consisting of compounds which are reactive toward isocyanates and have a number average molecular weight of from 62 to 399 g/mol,

where the components A2 and A3 do not contain any filled polyols,
a component A4 containing water and/or at least one physical blowing agent,
optionally a component A5 containing auxiliaries and additives and
a component B containing or consisting of diisocyanates and/or polyisocyanates,

where no styrene-acrylonitrile-filled polyols are present in the composition and the reaction is carried out at an index of from 90 to 110.

The invention preferably provides a process for producing polyurethane foam for the thermal and acoustic insulation of engines, wherein the polyurethane foam is obtained or is obtainable by reaction of a composition containing or consisting of
a component A1 containing or consisting of at least one filled polyol containing a filler composition comprising
   polyurea dispersions which are obtainable by reaction of diisocyanates and/or polyisocyanates with di and/or polyamines having primary and/or secondary amino groups and/or hydrazines in a polyol component and/or
   dispersions which contain urethane groups and are obtainable by reaction of alkanolamines with diisocyanates and/or polyisocyanates in a polyol component,
a component A2 containing or consisting of compounds which are reactive toward isocyanates and have a number average molecular weight of 400-18000 g/mol, preferably from 3500 to 5000 g/mol,
optionally a component A3 containing or consisting of compounds which are reactive toward isocyanates and have a number average molecular weight of from 62 to 399 g/mol,

where the components A2 and A3 do not contain any filled polyols,
a component A4 containing water and/or at least one physical blowing agent,
optionally a component A5 containing auxiliaries and additives and
a component B containing or consisting of diisocyanates and/or polyisocyanates,

where the reaction is carried out at an index of from 90 to 110.

A further preferred subject is a process for producing thermal and acoustic insulation for internal combustion engines using polyurethane foams, wherein the polyurethane foams are obtainable by reaction of
A1a filler-containing polyols, where the filler is a reaction product of diisocyanates and/or polyisocyanates with compounds having hydrogen atoms which are reactive toward isocyanates,
A1b optionally further filler-containing polyols which do not come under the definition of the component a1,
A2 optionally compounds which do not come under the definition of the component A1a or A1b and have a number average molecular weight of 400-18000 g/mol, and have hydrogen atoms which are reactive toward isocyanates,
A3 optionally compounds which do not come under the definition of the component A1a or A1b and have a number average molecular weight of 62-399 g/mol and have hydrogen atoms which are reactive toward isocyanates,
A4a water and/or physical blowing agents,
A4b optionally flame retardants,
A5 optionally auxiliaries and additives such as
   a) catalysts,
   b) surface-active additives,
   c) one or more additives selected from the group consisting of reaction retarders, cell regulators, pigments, dyes, stabilizers against aging and weathering influences, plasticizers, fungistatic and bacteriostatic substances, fillers and release agents,
and
B diisocyanates or polyisocyanates,

where the filler-containing polyols of components A1a and A1b are used in such amounts that the filler content resulting from the components A1a and A1b is, based on the total amount of the components A1a and A1b, A2 and A3, from 2 to 30% by weight of filler.

A further preferred subject is the process described in the previous paragraph, wherein the polyurethane foams are obtainable by reaction of
100 parts by weight (parts by wt.) of a component consisting of A1a and A1b, A2 and A3 and having the following composition:
A1a filler-containing polyols, where the filler is a reaction product of diisocyanates and/or polyisocyanates with compounds having hydrogen atoms which are reactive toward isocyanates,
A1b optionally further filler-containing polyols which do not come under the definition of the component A1a,
A2 optionally compounds which do not come under the definition of the component A1a or A1b and have a molecular weight 400-18000 g/mol and have hydrogen atoms which are reactive toward isocyanates,
A3 from 0 to 10 parts by weight (based on 100 parts by weight of the sum of the parts by weight of the components A1 to A3) of compounds which do not come under the definition of the component A1a or A1b and have a molecular weight of 62-399 g/mol and have hydrogen atoms which are reactive toward isocyanates,
A4a from 0.1 to 10 parts by weight (based on 100 parts by weight of the sum of the parts by weight of the components A1 to A3) of water and/or physical blowing agents,
A4b from 0 to 20 parts by weight (based on 100 parts by weight of the sum of the parts by weight of the components A1 to A3) of flame retardants,
A5 from 0 to 20 parts by weight (based on 100 parts by weight of the sum of the parts by weight of the components A1 to A3) of auxiliaries and additives such as
   a) catalysts,
   b) surface-active additives,
   c) one or more additives selected from the group consisting of reaction retarders, cell regulators, pigments, dyes, stabilizers against aging and weathering influences, plasticizers, fungistatic and bacteriostatic substances, fillers and release agents,
and
B diisocyanates or polyisocyanates,
where the filler-containing polyols of components A1a and A1b are used in such amounts that the filler content resulting from the components A1a and A1b is, based on the total amount of the components A1a and A1b, A2 and A3, from 2 to 30% by weight of filler and the reaction is carried out at an index of from 90 to 110.

Rigid polyurethane foam is a highly crosslinked, thermoset polymer which has been foamed to form a cellular structure having a low foam density. The thermoset character is reflected in the fact that the foam is not fusible and has a high softening point and good resistance to chemicals and solvents.

The components described in more detail below can be used for producing the polyurethane foams to be used according to the invention.

Components A1, A1a and A1b

The components A1, A1a and A1b are filler-containing polyols, where the filler is a reaction product of diisocyanates and/or polyisocyanates with compounds having hydrogen atoms which are reactive toward isocyanates.

Filler containing polyols contain finely dispersed solid particles in the form of a disperse phase in a base polyol. Filler-containing polyols can be prepared by polymerization of styrene and acrylonitrile or by reaction of diisocyanate with diamines or amino alcohols in active or inactive base polyols. A further industrially important group of filler-containing polyethers are polyurea or polyhydrazodicarboximide polyols. They are produced by reaction of further components in situ in the polyol. As reaction components, use is made of the isocyanates and diamines or hydrazine which are joined by polyaddition to give polyureas or polyhydrazodicarboxamides. Here, partial crosslinking with the hydroxyl groups of the polyether chain takes place. The stable dispersions obtained in this way are referred to as PUD polyethers.

Filler-containing polyols of the components A1a and A1b are preferably polyols having a filler composed of polyurea dispersions, known as PUD polyols, or polyols having a filler obtainable by reaction of alkanolamines with diisocyanates and/or polyisocyanates, known as PIPA polyols.

In a preferred embodiment, the invention provides a process in which component A1 or A1a is composed of

filler-containing polyols having a filler composition containing or consisting of a component A1.1 containing or consisting of polyurea dispersions which are obtainable by reaction of diisocyanates and/or polyisocyanates with diamines and/or polyamines having primary and/or secondary amino groups and/or hydrazines in a polyol component (PUD polyols),

and/or

filler-containing polyols having a filler composition containing or consisting of a component A1.2 containing or consisting of dispersions which contain urethane groups and are obtainable by reaction of alkanolamines with diisocyanates and/or polyisocyanates in a polyol component.

In a preferred embodiment, the components A1.1 and A 1.2 are used as a mixture, and in another embodiment the components A1.1 and A 1.2 are used in a weight ratio of A1.1:A 1.2 of from ≥30:70 to ≤70:30 and in a further preferred embodiment exclusively component A1.1 or exclusively component A1.2 is used as component A1 or A1a of the composition for producing the polyurethane foam.

The composition for carrying out the process of the invention preferably comprises filler-containing polyols having a filler composition made up of polyurea dispersions which are by reaction of diisocyanates and/or polyisocyanates with diamines and/or polyamines having primary and/or secondary amino groups and/or hydrazines in a compound which has from 1 to 8 primary and/or secondary hydroxyl groups and has a molecular weight of from 400 to 18000 g/mol.

The composition for carrying out the process of the invention preferably comprises filler-containing polyols having a filler composition made up of dispersions which contain urethane groups and are obtainable by reaction of alkanolamines with diisocyanates and/or polyisocyanates in a polyol component, particularly preferably in a polyol component which has from 1 to 8 primary and/or secondary hydroxyl groups and has a molecular weight of from 400 to 18000 g/mol.

Preferred hydroxyl group-comprising compounds used in the production of the filler-containing polyols according to the invention are compounds which have from 2 to 8 hydroxyl groups, especially ones having a molecular weight of from 1000 to 6000 g/mol, preferably from 2000 to 6000 g/mol, e.g. polyether polyols and polyester polyols which have at least two, generally from 2 to 8 but preferably from 2 to 6, hydroxyl groups and also polycarbonate polyols, polyether carbonate polyols and polyester amide polyols, as are known per se for the production of homogeneous polyurethanes and of cellular polyurethanes and as are described, for example, in EP-A 0 007 502, pages 8 to 15. Preference is given to polyether polyols having hydroxyl groups, particularly preferably polyether polyols having at least two hydroxyl groups. The polyether polyols are preferably prepared by addition of alkylene oxides (for example ethylene oxide, propylene oxide and butylene oxide or mixtures thereof) onto starters such as ethylene glycol, propylene glycol, glycerol, trimethylolpropane, pentaerythritol, sorbitol, mannitol and/or sucrose, so that a functionality in the range from 2 to 8, preferably from 2.5 to 6, particularly preferably from 2.5 to 4, can be set.

As component A1 or A1a of the composition for producing polyurethane foam, preference is given to using filler-containing polyols which are obtainable by reaction of a diisocyanate mixture of from 75 to 85% by weight of tolylene 2,4-diisocyanate (2,4-TDI) and from 15 to 25% by weight of tolylene 2,6-diisocyanate (2,6-TDI) with a diamine and/or hydrazine in a polyol component, preferably a polyether polyol, prepared by alkoxylation of a trifunctional starter (for example glycerol and/or trimethylolpropane).

Component A1 preferably contains from 5 to 35% by weight, preferably from 8 to 25% by weight, more preferably from 9 to 22% by weight, in each case based on the component A1, of a filler composition, in particular a filler composition composed of polyurea dispersions.

The at least one filled polyol of the component A1 preferably has a number average molecular weight in the range from 3000 to 5000 g/mol, preferably in the range from 3500 to 4500 g/mol, more preferably in the range from 3800 to 4100 g/mol.

The at least one filled polyol of the component A1 preferably has an OH number in accordance with DIN 53240 in the range from 10 to 40, preferably in the range from 15 to 35, more preferably in the range from 20 to 30.

The filled polyols of component A1a are used in such amounts that the filler content resulting from the component A1 or a1 is, based on the total amount of the components A1 and A2, preferably from 2 to 30% by weight, particularly preferably from 4 to 25% by weight, most preferably from 7 to 22% by weight, of filler.

As filled polyols of component A1a, preference is given to using exclusively PUD polyols in such amounts that the filler content resulting from the PUD polyol is, based on the total amount of the component A1 and A2, preferably from 2 to 30% by weight, particularly preferably from 4 to 25% by weight, most preferably from 7 to 22% by weight, of filler.

Particular preference is given to using PUD polyols having a proportion of PUD filler of from 2 to 25% by weight, most preferably from 8 to 22% by weight, in each case based on the PUD polyol, as component A1a. For example, in the case of a proportion of PUD filler of 20% by weight based on the PUD polyol and a ratio of 75 parts by weight of PUD polyol and 25 parts by weight of the component A2, in each case based on the sum of the components A1a to A2, a filler content of from 15% by weight, based on the total amount of the components A1a and A2, results.

Component A1b

One of the filled polyols described under component A1 or A1a is preferably used as component A1b.

The filled polyols of component A1b are used in such amounts that the filler content resulting from the component A1b, based on the total amount of the components A1a, A1b, A2 and A3, is ≤10% by weight, preferably ≤5% by weight, particularly preferably ≤2% by weight, of filler.

The composition for carrying out the process of the invention does not contain any SAN polyols.

Component A2

Component A2 contains or consists of compounds having at least two hydrogen atoms which are reactive toward isocyanates. For the present purposes, these are compounds which have amino groups, thio groups or carboxyl groups, preferably hydroxyl groups, in particular from 2 to 8 hydroxyl groups. Component A2 contains or consists of compounds which have a number average molecular weight of 400-18000 g/mol, preferably from 1000 to 6000 g/mol, more preferably from 2000 to 6000 g/mol, even more preferably from 3000 to 5000 g/mol. Component Aa preferably contains or consists of polyethers, polyesters, polycarbonates or polyester amides which have at least 2, generally from 2 to 8, but preferably from 2 to 6, hydroxyl groups. The polyether polyols having at least two hydroxyl groups are preferred for the purposes of the invention. The polyether polyols are preferably prepared by addition of alkylene oxides (for example ethylene oxide, propylene oxide and butylene oxide or mixtures thereof) or onto starters such as ethylene glycol, propylene glycol, glycerol, trimethylolpropane, pentaerythritol, sorbitol, mannitol and/or sucrose, so that a functionality in the range from 2 to 8, preferably from 2.5 to 6, particularly preferably from 2.5 to 4, can be set. Component A2 preferably contains or consists of polyether polyols which are prepared from polyethylene oxide, polypropylene oxide and glycerol, optionally in the presence of a catalyst.

The compounds of the component A2 preferably have an OH number in accordance with DIN 53240 in the range from 10 to 40, preferably from 15 to 35, more preferably from 25 to 30.

In one embodiment, component A2 contains or consists of a polyethylene oxide-polypropylene oxide polyether which is based on glycerol and has a number average molecular weight in the range from 4000 to 5000 g/mol and an OH number in accordance with DIN 53240 in the range from 25 to 35.

Component A3

The composition according to the invention for producing a polyurethane foam optionally contains a component A3 containing or consisting of compounds which are reactive toward isocyanates and have a number average molecular weight of from 62 to 399 g/mol, preferably from 80 to 200 g/mol, more preferably from 100 to 180 g/mol. The compounds preferably have hydroxyl groups and/or amino groups and/or thiol groups and/or carboxyl groups, preferably hydroxyl groups and/or amino groups. These compounds preferably serve as chain extenders or crosslinkers. These compounds generally have from 2 to 8, preferably from 2 to 4, hydrogen atoms which are reactive toward isocyanates. The compounds present in component A3 preferably have an OH number of from 500 to 2000, more preferably from 800 to 1500, even more preferably from 1000 to 1300. Component A3 preferably contains or consists of ethanolamine, diethanolamine, triethanolamine, sorbitol and/or glycerol, more preferably triethanolamine.

Component A4 or A4a

Component A4 or A4a contains water and/or at least one physical blowing agent. Physical blowing agents are preferably carbon dioxide and/or volatile organic substances such as dichloromethane.

Component A5

As component A5, use is optionally made of auxiliaries and additives such as
a) catalysts (activators),
b) surface-active additives (surfactants) such as emulsifiers and foam stabilizers,
c) one or more additives selected from the group consisting of reaction retarders (e.g. acidic materials such as hydrochloric acid or organic acid halides), cell regulators (for example paraffins or fatty alcohols or polydimethylsiloxanes), pigments, dyes, stabilizers against aging and weathering influences, plasticizers, fungistatic and bacteriostatic substances, fillers (for example barium sulfate, kieselguhr, carbon black or slurry chalk) and release agents.

Examples are preferred auxiliaries and additives and also details regarding the use and mode of action of these auxiliaries and additives are described in Kunststoff-Handbuch, Volume VII, edited by G. Oertel, Carl-Hanser-Verlag, Munich, 3rd edition, 1993, e.g. on pages 104-127.

As catalysts, preference is given to using: aliphatic tertiary amines (for example trimethylamine, tetramethylbutandiamine, 3-dimethylaminopropylamine, N,N-Bis(3-dimethylaminopropyl)-N-isopropanolamine), cycloaliphatic tertiary amines (for example 1,4-diaza[2.2.2]bicyclooctane), aliphatic amino ethers (for example Bisdimethylaminoethyl ether, 2-(2-dimethylaminoethoxy)ethanol and N,N,N-trimethylaminoethyl N-hydroxyethylaminoethyl ether), cycloaliphatic amino ethers (for example N-ethylmorpholine), aliphatic amidines, cycloaliphatic amidines, urea and derivatives of urea (for example aminoalkylureas, in particular (3-dimethylaminopropylamino)urea). A particularly preferred catalyst is 1,4-diaza[2.2.2]bicyclooctane.

It is also possible to use tin(II) salts of carboxylic acids as catalysts, with the parent carboxylic acid in each case preferably having from 2 to 20 carbon atoms. Particular preference is given to the tin(II) salt of 2-ethylhexanoic acid (i.e. tin(II) 2-ethylhexanoate), the tin(II) salt of 2-butyloctanoic acid, the tin(II) salt of 2-hexyldecanoic acid, the tin(II) salt of neodecanoic acid, the tin(II) salt of oleic acid, the tin(II) salt of ricinoleic acid and tin(II) laurate. Tin(IV) compounds such as dibutyltin oxide, dibutyltin dichloride, dibutyltin diacetate, dibutyltin dilaurate, dibutyltin maleate or dioctyltin diacetate can also be used as catalysts.

Of course, all the abovementioned catalysts can be used as mixtures.

Component A5 preferably contains urea, 1,4-diaza[2.2.2]bicyclooctane, a mixture of modified polyether siloxanes and a polyol/carbon black mixture containing about 15% by weight of carbon black.

Component B

Component B contains diisocyanates and/or polyisocyanates. Component B preferably contains aliphatic, cycloaliphatic, araliphatic, aromatic and heterocyclic polyisocyanates as are described, for example, by W. Siefken in Justus Liebigs Annalen der Chemie, 562, pages 75 to 136, for example those of the formula (I)

Q(NCO)ₙ (I)

where
n=2-4, preferably 2-3,

and
Q is an aliphatic hydrocarbon radical having 2-18, preferably 6-10, carbon atoms, a cycloaliphatic hydrocarbon radical having 4-15, preferably 6-13, carbon atoms or an araliphatic hydrocarbon radical having 8-15, preferably 8-13, carbon atoms.

In general, preference is given to industrially readily available polyisocyanates, e.g. tolylene 2,4- and 2,6-diisocyanate, and any mixtures of these isomers (“TDI”); polyphenylpolymethylene polyisocyanates as are prepared by aniline-formaldehyde condensation and subsequent phosgenation (“crude MDI”) and polyisocyanates having carbodiimide groups, urethane groups, allophanate groups, isocyanurate groups, urea groups or biurete groups (“modified polyisocyanates”), in particular the modified polyisocyanates derived from tolylene 2,4- and/or 2,6-diisocyanate or from diphenylmethane 4,4′- and/or 2,4′-diisocyanate. Component B preferably contains or consists of at least one compound selected from the group consisting of diphenylmethane 4,4′-diisocyanate, diphenylmethane 2,4′-diisocyanate, diphenylmethane 2,2′-diisocyanate and polyphenylpolymethylene polyisocyanate (“Multi-ring MDI”) or mixtures thereof.

As component B, particular preference is given to using a diphenylmethane diisocyanate mixture consisting of
a) from 35 to 95% by weight of diphenylmethane 4,4′-diisocyanate and
b) from 5 to 65% by weight of diphenylmethane 2,2′-diisocyanate and/or diphenylmethane 2,4′-diisocyanate and
c) from 0 to 56% by weight, preferably from 0 to 52% by weight, of polyphenylpolymethylene polyisocyanate (“multi-ring MDI”) and/or diphenylmethane 2,2′-, 2,4′-, 4,4′-diisocyanate and/or pMDI-based carbodiimides, uretdiones or uretdionimines.

Very particular preference is given to using a diphenylmethane diisocyanate mixture consisting of
a) from 40 to 42% by weight of diphenylmethane 4,4′-diisocyanate and
b) from 6 to 9% by weight of diphenylmethane 2,2′-diisocyanate and/or diphenylmethane 2,4′-diisocyanate and
c) from 50 to 52% by weight of polyphenylpolymethylene polyisocyanate (“Multi-ring MDI”) and/or diphenylmethane 2,2′-, 2,4′-, 4,4′-diisocyanate and/or pMDI-based carbodiimides, uretdiones or uretdionimines

as component B.

The composition for producing polyurethane foam for thermal and acoustic insulation of engines preferably does not contain any flame retardants, in particular no phosphorus-containing or halogen-containing flame retardants or melamine. The composition preferably does not contain any flame retardants such as phosphates or phosphonates, e.g. diethyl ethanephosphonate (DEEP), triethyl phosphate (TEP) and dimethyl propylphosphonate (DMPP), brominated esters, brominated ethers (Ixol) or brominated alcohols such as dibromneopentyl alcohol, tribromneopentyl alcohol, tetrabromphthalate diol (DP 54) and PHT 4-diol or chlorinated phosphates such as tris(2-chlorethyl) phosphate, tris-(2-chlorpropyl) phosphate (TCPP), tris(1,3-dichlorpropyl) phosphate, tricresyl phosphate, diphenyl cresyl phosphate (DPC), tris-(2,3-dibromopropyl) phosphate, tetrakis-(2-chlorethyl)ethylene diphosphate, dimethyl methanephosphonate, diethyl diethanolaminomethylphosphonate or commercial halogen-containing flame retardant polyols or mixtures thereof.

According to the invention, flame retardants are not the filler-containing polyols of component A1 or a1 or a2.

The composition for producing polyurethane foam is reacted at an index of from 90 to 110, preferably from 95 to 105, more preferably at an index of 100. The index (isocyanate index) is the ratio of the amount of isocyanate actually used to the stoichiometric, i.e. calculated, amount of isocyanate groups (NCO):

Index=[(amount of isocyanate used):(calculated amount of isocyanate)]·100 (II)

In a preferred embodiment, the composition contains or consists of
from 10.0 to 98.9% by weight, preferably from 20.0 to 55.0% by weight, of the component A1,
from 1.0 to 88.9% by weight, preferably from 37.0 to 72.0% by weight, of the component A2,
optionally from 0 to 5% by weight, preferably from 0.2 to 2.0% by weight, of the component A3,
from 0.1 to 10.0% by weight, preferably from 0.5 to 2.0% by weight, of the component A4,
optionally from 0 to 20.0% by weight, preferably from 1.0 to 4.0% by weight, of the component A5,

where the parts by weight of the components A1 to A5 add up to 100.

To produce the polyurethane foams, the reaction components are preferably reacted by the one-shot process, the prepolymer process or the semiprepolymer process known per se, with use preferably being made of mechanical apparatuses. Details regarding processing apparatuses, which also come into question according to the invention, are described in Vieweg and Höchtlen (editors): Kunststoff-Handbuch, Volume VII, Carl-Hanser-Verlag, Munich 1966, pages 121 to 205. The process for producing the polyurethane foam of the invention is preferably a one-shot process in which the components of the composition are metered in true to the formulation and admixed and then introduced into a molding apparatus. The molding apparatus preferably has a temperature of from 45 to 70° C. The mixed composition preferably cures in the mold after from 5 to 10 minutes, more preferably after from 6 to 8 minutes, and the polyurethane foam obtained can be taken from the mold.

In a preferred embodiment, the components A1 to A5 and B are reacted in a one-shot process. In an alternative preferred embodiment, a prepolymer is firstly formed from the polyol component A2 and the isocyanate component B and is then reacted with the remaining reactants.

An embodiment of the invention provides a polyurethane foam for the thermal and acoustic insulation of engines which is obtained by or is obtainable by the process of the invention. The polyurethane foam obtained by the process of the invention preferably has a foam density in accordance with DIN EN ISO 845 in the range from 100 to 250 kg/m³, preferably in the range from 130 to 200 kg/m³, more preferably in the range from 140 to 170 kg/m³. The polyurethane foam obtained by the process of the invention preferably has a compressive strength CV40 [kPa] in accordance with DIN EN ISO 3386-1-98 of from 30 to 80 kPa, more preferably from 40 to 60 kPa.

An embodiment provides for the use of a polyurethane foam obtained by the process of the invention for the thermal and acoustic insulation of engines.

A further embodiment provides insulation for engines containing a polyurethane foam which has been obtained by the process of the invention, in particular as molding, where the molding is, in particular, a self-supporting molding; in particular, the molding largely encloses the outer surface of an engine.

A further embodiment provides a process for producing the insulation of engines, comprising the following steps
provision of a composition as claimed in any of claims 1 to 9 and mixing of the components to give a mixture,
application of the mixture directly to at least sections of the outer surface of an internal combustion engine, in particular application over most of the area,
allowing the mixture to react.

Here, the outer surface of the internal combustion engine preferably comprises the engine block, the valve cover, the crankshaft housing, the camshaft housing and/or the air intake.

The polyurethane foams are, according to the invention, used for thermal and acoustic insulation for internal combustion engines, optionally including the auxiliary components. It is possible here to insulate the engine either entirely or partly or else only the engine or the engine together with the auxiliary components. According to the invention, the term engine refers to the outer surface of the internal combustion engine, preferably the engine block, the valve cover, the crankshaft housing, the camshaft housing and/or the air intake.

In a preferred embodiment of the invention, the thermal and acoustic insulation according to the invention can be joined by material-to-material bonding to the engine block. This can be effected, for example, by direct foaming of the rigid polyurethane foam onto the engine block. Here, either only the engine housing or else the engine housing and the auxiliary components can be surrounded with foam. The advantage of this embodiment is complete sealing of the engine housing, which leads to very good thermal and in particular acoustic insulation. In addition, this process is very easy to carry out since only the liquid foam components have to be applied to the engine surface and no separate shaping and adaptation of the insulation has to be carried out. However, a disadvantage is that when carrying out work on the engine, the insulation has to be removed, which is in all cases associated with destruction of the latter.

A further possible way of effecting material-to-material-bonded insulation of engines can be to produce the insulation in one piece or in a plurality of parts, preferably as moldings, and then adhesively bond these to the engine housing. In this way too, it is possible to achieve complete sealing of the engine housing with the abovementioned advantages. A disadvantage is that the moldings firstly have to be produced and then joined in a separate working step to the engine housing. Compared to direct application of the foam, this process has the advantage that when working on the engine, the insulation may be able to be removed by releasing the adhesive bond and subsequently can be applied again.

In a further preferred embodiment of the invention, the insulation can be configured as self-supporting unit. Here, moldings composed of polyurethane foam can be produced and these can be installed around the engine. Here too, it is once again possible to configure the insulation as one piece or in the form of a plurality of parts. In addition, it is once again possible for only the engine or the engine including the auxiliary components to be entirely or partly enveloped. The advantage of this embodiment is the simple removal of the insulation in the case of maintenance or repair work on the engine and possible reuse of the insulation. A disadvantage compared to direct application of foam to the engine is the greater outlay in terms of production and installation of the insulation. In addition, loosening of the insulation and thus possible impairment of the thermal and acoustic insulation of the engine can occur during operation of the engine. Here too, configuration of the insulation as a plurality of individual parts is particularly advantageous in order to simplify repair and maintenance work on the engine.

Of course, in the latter two embodiments, the insulation or the individual parts of the insulation can be produced not as molding but as slabstock foam which is then cut into the appropriate shape.

In a further embodiment of the invention, the self-supporting units can also be configured as composite elements.

It is thus possible to provide the side facing away from the engine with a stable shell of polymer in order to improve the mechanical strength of the insulation. As polymers for producing the shell, it is possible to use, for example, polyolefins, polystyrene, polyamide or polycarbonates. However, it is also possible and advantageous in the interests of recyclability to use compact polyurethanes, for example RIM-PU, for producing said shell. The polymers used for producing the shell can also contain reinforcing materials, for example glass fibers.

The side facing the engine can contain a layer of at least one thermally stable material. Here, it is possible to use inorganic materials, for example mineral fibers, and also organic materials, in particular foams, for example melamine-formaldehyde foam. It is also possible to use composite elements composed of a plurality of polyurethane foams, in which case the polyurethane foam used for the side facing away from the engine should display particularly good mechanical strength and the polyurethane foam used for the side facing the engine should display particularly good thermal stability.

The composite elements can also contain at least one layer which serves as structure-borne noise insulation. Examples here are polyurethanes containing specific fillers, for example barite. Where possible, these layers are applied in the middle of the composite element or on the side of the composite element facing away from the engine, since they are usually not heat resistant. In this case, preference is given to the outer polymer shell having a thickness of from 0.5 to 5.0 mm, the layer for thermal insulation having an average thickness of from 5.0 to 70 mm and the layer for structure-borne noise insulation having a thickness of from 0.5 to 10 mm.

To protect against aggressive liquids such as fuel, engine oil, brake fluid or antifreeze, the inside of the insulation can also be provided with a metal layer, for example a thin aluminum layer. This also leads to additional reflection of heat radiation. In addition, the outer surface composed of metal can also be decorated.

In a first embodiment, the invention provides a process for producing polyurethane foam for the thermal and acoustic insulation of engines, wherein the polyurethane foam is obtained or is obtainable by reaction of a composition containing or consisting of
a component A1 containing or consisting of at least one filled polyol,
a component A2 containing or consisting of compounds which are reactive toward isocyanates and have a number average molecular weight of from 400 to 18000 g/mol,
optionally a component A3 containing or consisting of compounds which are reactive toward isocyanates and have a number average molecular weight of from 62 to 399 g/mol,

where the components A2 and A3 do not contain any filled polyols,
a component A4 containing water and/or at least one physical blowing agent,
optionally a component A5 containing auxiliaries and additives and
a component B containing or consisting of diisocyanates and/or polyisocyanates,

where no styrene-acrylonitrile-filled polyols are present in the composition and the reaction is carried out an index of from 90 to 110.

In a second embodiment, the invention provides a process as per embodiment 1, wherein the at least one filled polyol of the component A1 contains a filler composition made up of
polyurea dispersions which are obtainable by reaction of diisocyanates and/or polyisocyanates with diamines and/or polyamines having primary and/or secondary amino groups and/or hydrazines in a polyol component and/or
dispersions which contain urethane groups and are obtainable by reaction of alkanolamines with diisocyanates and/or polyisocyanates in a polyol component.

In a third embodiment, the invention provides a process as per embodiment 1 or 2, wherein the component A1 contains from 5 to 35% by weight, preferably from 8 to 25% by weight, in each case based on the component A1, of a filler composition, in particular a filler composition made up of polyurea dispersions.

In a fourth embodiment, the invention provides a process as per one of the embodiments 1 to 3, wherein the at least one filled polyol of the component A1 has a number average molecular weight in the range from 3000 to 5000 g/mol, preferably in the range from 3500 to 4500 g/mol, more preferably in the range from 3800 to 4100 g/mol.

In a fifth embodiment, the invention provides a process as per one of the embodiments 1 to 4, wherein the at least one filled polyol of the component A1 has an OH number in accordance with DIN 53240 in the range from 10 to 40, preferably in the range from 15 to 35, more preferably in the range from 20 to 30.

In a sixth embodiment, the invention provides a process as per one of the embodiments 1 to 5, wherein the compounds of the component A2 have an OH number in accordance with DIN 53240 in the range from 10 to 40, preferably in the range from 15 to 35.

In a seventh embodiment, the invention provides a process as per one of the embodiments 1 to 6, wherein the component B contains or consists of at least one compound selected from the group consisting of diphenylmethane 4,4′-diisocyanate, diphenylmethane 2,4′-diisocyanate, diphenylmethane 2,2′-diisocyanate and polyphenylpolymethylene polyisocyanate (“multi-ring MDI”) or mixtures thereof.

In an eighth embodiment, the invention provides a process as per any of the embodiments 1 to 7, wherein the composition does not contain any flame retardants, in particular no phosphorus-containing or halogen-containing flame retardants or melamine.

In a ninth embodiment, the invention provides a process as per any of the embodiments 1 to 8, wherein the composition contains or consists of
from 10.0 to 98.9% by weight, preferably from 20.0 to 55.0% by weight, of the component A1,
from 1.0 to 88.9% by weight, preferably from 37.0 to 72.0% by weight, of the component A2,
optionally from 0 to 5% by weight, preferably from 0.2 to 2.0% by weight, of the component A3,
from 0.1 to 10.0% by weight, preferably from 0.5 to 2.0% by weight, of the component A4,
optionally from 0 to 20.0% by weight, preferably from 1.0 to 4.0% by weight, of the component A5,

where the parts by weight of the components A1 to A5 add up to 100.

In a tenth embodiment, the invention provides a polyurethane foam for the thermal and acoustic insulation of engines obtained by or obtainable by a process as per any of the embodiments 1 to 9.

In an eleventh embodiment, the invention provides a polyurethane foam as per embodiment 10, wherein the polyurethane foam has a foam density in accordance with DIN EN ISO 845 in the range from 100 to 250 kg/m³, preferably in the range from 130 to 200 kg/m³, more preferably in the range from 140 to 170 kg/m³.

In a twelfth embodiment, the invention provides for the use of a polyurethane foam as per embodiment 10 or 11 for the thermal and acoustic insulation of engines.

In a thirteenth embodiment, the invention provides insulation of engines containing a polyurethane foam as per embodiment 10 or 11, in particular as molding, wherein the molding is, in particular, a self-supporting molding and in particular encloses most of the outer surface of an engine.

In a fourteenth embodiment, the invention provides a process for producing insulation as per embodiment 13, comprising the following steps
provision of a composition as per any of the embodiments 1 to 9 and mixing of the components to give a mixture,
internal combustion engine, in particular application over most of the area,
allowing the mixture to react.

In a fifteenth embodiment, the invention provides a process as per embodiment 14, wherein the outer surface of the internal combustion engine comprises the engine block, the valve cover, the crankshaft housing, the camshaft housing and/or the air intake.

### EXAMPLES

Polyurethane foams were produced using the following components:
A1 Desmophen 7619 W, a filler-containing polyol comprising 21.6% of polyurea dispersion (PUD) as filler and 78.4% of a polyethylene oxide-polypropylene oxide polyether based on glycerol and having a number average molecular weight of 4007 g/mol and an OH number of 28
   Hyperlite Polyol 1650, a filler-containing polyol comprising 43% of styrene-acrylonitrile (SAN) as filler and 57% of a polyethylene oxide-polypropylene oxide polyether based on glycerol and having a number average molecular weight of 8332 g/mol and an OH number of 20
A2 Desmophen 10 WF 22 consisting of a polyethylene oxide-polypropylene oxide polyether based on glycerol and having a number average molecular weight of 4500 g/mol and an OH number of 28
A2 Desmophen 41 WB01 consisting of a polyethylene oxide-polypropylene oxide polyether based on glycerol and having a proportion of more than 70% of ethylene oxide and having a number average molecular weight of 4548 g/mol and an OH number of 37
A2 Desmophen 10 WF 15 consisting of a polyethylene oxide-polypropylene oxide polyether based on glycerol and having a number average molecular weight of 4007 g/mol and an OH number of 35
A3 Triethanolamine having a number average molecular weight of 149 g/mol and an OH number of 1128
A4 Water
A5 Urea
A5 Dabco 33 LV consisting of 33% of 1,4-diazabicyclo[2.2.2]octane dissolved in 67% of dipropylene glycol
A5 Tegostab B 8715 LF 2 consisting of a mixture of modified polyether siloxanes
A5 Isopur Black Paste consisting of a polyol-carbon black mixture containing about 15% of carbon black.

The isocyanates of the component B have the following compositions:

TABLE 1

| | | DESMODUR 85/25 | DESMODUR 44 V 20 L |
|---|---|---|---|
| 2,2′-MDI | % | 3.0 | 0.1 |
| 2,4′-MDI | % | 23.0 | 3.3 |
| 4,4′-MDI | % | 59.0 | 36.6 |
| Multi-ring MDI | % | 15.0 | 60.0 |
| NCO content | % | 32.6 | 31.4 |

Polyurethane foams were produced by the following process:

The components A1 to A6 were weighed into a beaker having a volume of 1.851 and mixed by means of a stirrer for 15 s at 4200 rpm. The isocyanate of the component B was weighed out and added and the mixture was stirred at the same speed for a further 5 s.

The mixture was transferred into a heated aluminum mold (about 50° C., volume: Examples 1-3 and 6-11: 5 l, example 4: 2.8 l) and removed from the mold again after a curing time of 7.5 minutes.

The foam density was determined in accordance with DIN EN ISO 845 on a test specimen from the core of the molding.

The compressive strength CV 40 was determined in accordance with DIN EN ISO 3386-1-98.

Carrying out a burning test in accordance with FMVSS 302 or directive 95/28/EC:

In the experimental setup, a combustion chamber having the dimensions 70×66×40 cm and ventilation possibility was equipped with a Bunsen burner on a movable rail. A sample holder for a horizontal test specimen having the dimensions 150×90×13 mm is introduced into the chamber in such a way that a 38 mm long flame of the Bunsen burner can reach precisely to an edge of the test specimen.

The sample or the sample holder are marked at 25 mm and 125 mm. After lighting the Bunsen burner, same is brought on the rail to the edge of the test specimen and left there for 15 s. The Bunsen burner is then moved back to the starting position at which there is no contact between the flame and the test specimen.

The spread of the flame is then observed and the time from when the 25 mm mark is exceeded until self-extinguishing occurs or until the 125 mm mark is reached is determined. The burning speed in mm/min is calculated therefrom.

As further observation, the dripping behavior is noted. Here, it is relevant whether the foam drips and, if so, whether these drops themselves burn or do not burn.

The requirements for the engine space are satisfied when the burning speed does not exceed 0 mm/min. For this purpose, the first measurement mark at 25 mm must not be reached by the flame. Non-burning dripping is a further desirable criterion.

The composition of the polyurethane foams is indicated in tables 2 and 3 below. The weights reported are in each case in % by weight.

TABLE 2

| | | According to the invention | | | | Comparison | | | | |
|---|---|---|---|---|---|---|---|---|---|---|
| | Example | 1 | 2 | 3 | 4 | 5 | 6 | 7 | 8 | 9 |
| A1 | DESMOPHEN 7619 W | 48.85 | 53.71 | 24.40 | 48.88 | — | 15.02 | 15.02 | 43.96 | 43.96 |
| | (PUD polyol) | | | | | | | | | |
| | Hyperlite polyol 1650 | — | — | — | — | 24.37 | 27.99 | 27.99 | | |
| | (SAN-filled polyol) | | | | | | | | | |
| A2 | DESMOPHEN 10WF22 | — | — | — | 43.99 | — | — | — | — | — |
| A2 | DESMOPHEN 41WB01 | 2.93 | 2.93 | 2.93 | 2.93 | 2.92 | 2.93 | 2.93 | 2.93 | 2.93 |
| A2 | DESMOPHEN 10WF15 | 43.97 | 39.06 | 68.31 | — | 68.23 | 49.65 | 49.65 | 48.84 | 48.84 |
| A3 | Triethanolamine | 1.22 | 1.22 | 1.22 | 1.22 | 1.22 | 1.22 | 1.22 | 1.22 | 1.22 |
| A4 | Water | 1.30 | 1.35 | 1.42 | 1.20 | 1.54 | 1.46 | 1.35 | 1.32 | 1.32 |
| A5 | Tegostab B8715LF2 | 0.24 | 0.24 | 0.24 | 0.24 | 0.24 | 0.24 | 0.24 | 0.24 | 0.24 |
| A5 | ISOPUR BLACK | 0.49 | 0.49 | 0.49 | 0.49 | 0.49 | 0.49 | 0.49 | 0.49 | 0.49 |
| | PASTE N | | | | | | | | | |
| A5 | Urea | 0.80 | 0.80 | 0.80 | 0.80 | 0.80 | 0.80 | 0.80 | 0.80 | 0.80 |
| A5 | Dabco 33LV | 0.20 | 0.20 | 0.20 | 0.24 | 0.19 | 0.20 | 0.20 | 0.20 | 0.20 |
| B | DESMODUR44 V 20 L | 25.05 | 25.16 | 25.33 | 18.68 | 24.97 | 17.27 | 24.67 | 17.54 | 30.06 |
| B | DESMODUR 85/25 | 8.35 | 8.39 | 8.44 | 12.45 | 8.32 | 5.76 | 8.22 | 5.85 | 10.02 |
| | Index (100 NCO/OH) | 100 | 100 | 100 | 100 | 100 | 70 | 100 | 70 | 120 |
| | Mixing ratio to 100 pbw | 33.4 | 33.5 | 33.8 | 31.1 | 33.3 | 23.0 | 32.9 | 23.4 | 40.1 |
| | of polyol: Iso | | | | | | | | | |

| | | | | | | | | | |
|---|---|---|---|---|---|---|---|---|---|
| Foam density [kg/m³] | 153 | 149 | 144 | 148 | 154 | 168 | 158 | 173 | 146 |
| DIN EN ISO 845 | | | | | | | | | |
| Compressive strength, CV40 | 64 | 54 | 44 | 44 | 60 | 44 | 76 | 40 | 76 |
| [kPa] | | | | | | | | | |
| DIN EN ISO 3386-1-98 | | | | | | | | | |
| Mark at 25 mm not reached and | Yes | Yes | Yes | Yes | No | Yes | Yes | Yes | Yes |
| thus burning rate of 0 mm/min, | | | | | | | | | |
| Mark at 25 mm reached and | — | — | — | — | Yes | — | — | — | — |
| burning rate is < 100 mm/min | | | | | | | | | |
| Non-burning dripping [yes/no] | Yes | Yes | yes | Yes | No | No | No | No | No |
| | (non- | (no | (no | (no | (burning | (burning | (burning | (burning | (burning |
| | burning | dripping) | dripping) | dripping) | drops) | drops) | drops) | drops) | drops) |
| | drops) | | | | | | | | |

TABLE 3

| | | | According to | |
|---|---|---|---|---|
| | | Comparison | the invention | |
| | Example | 10 | 11 | 12 |
| A1 | DESMOPHEN 7619 W | 27.99 | 43.96 | 43.96 |
| | (PUD polyol) | | | |
| | Hyperlite polyol 1650 | 15.02 | — | — |
| | (SAN-filled polyol) | | | |
| A2 | DESMOPHEN 10WF15 | 49.65 | 48.84 | 48.84 |
| | DESMOPHEN 41WB01 | 2.93 | 2.93 | 2.93 |
| A3 | Triethanolamine | 1.22 | 1.22 | 1.22 |
| A4 | Water | 1.46 | 1.32 | 1.32 |
| A5 | Tegostab B8715LF2 | 0.24 | 0.24 | 0.24 |
| A5 | ISOPUR BLACK PASTE | 0.49 | 0.49 | 0.49 |
| | N | | | |
| A5 | Urea | 0.80 | 0.80 | 0.80 |
| A5 | Dabco 33LV | 0.20 | 0.20 | 0.20 |
| B | DESMODUR44V20L | 27.13 | 22.55 | 27.56 |
| B | DESMODUR 85/25 | 9.04 | 7.52 | 9.19 |
| | Index (100 NCO/OH) | 110 | 90 | 110 |
| | Mixing ratio to | 36.2 | 30.1 | 36.7 |
| | 100 pbw polyol:Iso | | | |
| | Foam density [DIN | 164 | 157 | 142 |
| | EN ISO 845] | | | |
| | Compressive strength, | 105 | 50 | 59 |
| | CV40 [DIN EN ISO | | | |
| | 3386] | | | |
| | Mark at 25 mm not | No | Yes | Yes |
| | reached and thus burning | | | |
| | speed is 0 mm/min | | | |
| | Mark at 25 mm reached | Yes | — | — |
| | and burning speed | | | |
| | is <100 mm/min | | | |
| | non-burning dripping | No | Yes | Yes |
| | | (burning | (non-burning | (no |
| | | drops) | drops) | dripping) |

In the case of the polyurethane foams of comparative examples 6 and 8, which were produced at an index of 70, a higher foam density was necessary for the aluminum mold to be completely filled after complete expansion of the composition for producing the foam. In the case of polyurethane foam of comparative examples 9 and 12, on the other hand, the foam density had to be reduced somewhat since otherwise the pressure in the mold becomes too high.

The experimental data for examples 1 to 4 and also 11 and 12 according to the invention show that the polyurethane foams of the invention satisfy the flame protection requirements necessary for use in the engine compartment, or on the engine. For none of these foams did the burning speed exceed the threshold of 0 mm/min and the first measurement mark at 25 mm was also not reached for any of these foams. In addition, the burning tests demonstrate that none of the foams according to the invention form burning drops on combustion. The foams according to the invention of examples 2 to 4 and 12 even do not form any drops at all during combustion.

In comparison thereto, burning drops were formed during combustion of the foam of comparative example 5. This foam also did not satisfy the requirements for burning speed. A styrene-acrylonitrile-filled polyol was used as filled polyol in comparative example 5, while a polyurea-dispersed polyol was used as filled polyol in the examples according to the invention. The comparison of the examples according to the invention with comparative example 5 unambiguously shows that the use of a polyol filled with polyurea dispersion leads to improved fire protection properties compared to the use of a styrene-acrylonitrile-filled polyol. The comparison of example 3 according to the invention with comparative example 5, in particular, shows that the technical effect is unambiguously attributable to the type of filled polyol used. These two examples differ only in respect of the type of filled polyol which was used.

Comparative examples 6, 7 and 10 show that a mixture of different filled polyols does not lead to the desired technical effect. The polyurethane foams of comparative examples 6, 7 and 10 contain both a polyurea-dispersed polyol and a styrene-acrylonitrile-filled polyol and both formed burning drops during combustion.

Comparative examples 8 and 9 show that the index at which the polyurethane foams are produced also has effects on the burning behavior of the foams. The foam of comparative example 8 was synthesized at an index of 70 and the foam of comparative example 9 at an index of 120. Both foams contained a polyurea-dispersed polyol as filled polyol and formed burning drops during combustion.

1. A process for producing polyurethane foam for the thermal and acoustic insulation of engines, wherein the polyurethane foam is obtained by reaction of a composition comprising
a component A1 comprising at least one filled polyol,
a component A2 comprising a compound which is reactive toward isocyanates and having a number average molecular weight of from 400 to 18000 g/mol,
optionally a component A3 comprising a compound which is reactive toward isocyanates and having a number average molecular weight of from 62 to 399 g/mol,
wherein the components A2 and A3 do not contain any filled polyols,
a component A4 comprising water and/or at least one physical blowing agent,
optionally a component A5 comprising an auxiliary component, an additive, or a combination thereof, and
a component B comprising a diisocyanate and/or a polyisocyanate,
wherein no styrene-acrylonitrile-filled polyols are present in the composition and the reaction is carried out at an index of from 90 to 110.

2. The process as claimed in claim 1, wherein the at least one filled polyol of the component A1 comprises a filler composition comprising
a polyurea dispersion which is obtained by reaction of a diisocyanate and/or a polyisocyanate with a diamine and/or a polyamine having primary and/or secondary amino groups and/or a hydrazine in a polyol component and/or
a dispersion which contains urethane groups and is obtainable by reaction of an alkanolamine with a diisocyanate and/or a polyisocyanate in a polyol component.

3. The process as claimed in claim 1, wherein the component A1 comprises from 5 to 35% by weight, based on the component A1, of a filler composition.

4. The process as claimed in claim 1, wherein the at least one filled polyol of the component A1 has a number average molecular weight in the range from 3000 to 5000 g/mol.

5. The process as claimed in claim 1, wherein the at least one filled polyol of the component A1 has an OH number in accordance with DIN 53240 in the range from 10 to 40.

6. The process as claimed in claim 1, wherein the compound of the component A2 has an OH number in accordance with DIN 53240 in the range from 10 to 40.

7. The process as claimed in claim 1, wherein the component B comprises at least one of diphenylmethane 4,4′-diisocyanate, diphenylmethane 2,4′-diisocyanate, diphenylmethane 2,2′-diisocyanate, polyphenylpolymethylene polyisocyanate (“multi-ring MDI”), and mixtures thereof.

8. The process as claimed in claim 1, wherein the composition does not contain any flame retardants.

9. The process as claimed in claim 1, wherein the composition comprises
from 10.0 to 98.9% by weight of the component A1,
from 1.0 to 88.9% by weight of the component A2,
optionally from 0 to 5% by weight of the component A3,
from 0.1 to 10.0% by weight of the component A4,
optionally from 0 to 20.0% by weight of the component A5,
wherein the parts by weight of the components A1 to A5 add up to 100%.

10. A polyurethane foam for the thermal and acoustic insulation of engines obtained by a process as claimed in claim 1.

11. The polyurethane foam as claimed in claim 10, wherein the polyurethane foam has a foam density in accordance with DIN EN ISO 845 in the range from 100 to 250 kg/m³.

12. An internal combustion engine, comprising the polyurethane foam of claim 10 applied to an outer surface of the internal combustion engine.

13. An insulation of engines comprising a polyurethane foam as claimed in claim 10.

14. A process for producing insulation as claimed in claim 13, comprising the following steps
a) providing a composition as claimed in claim 1 and mixing of the components to give a mixture,
b) applying the mixture directly to at least part of an outer surface of an internal combustion engine,
c) allowing the mixture to react.

15. The process as claimed in claim 14, wherein the outer surface of the internal combustion engine comprises an engine block, a valve cover, a crankshaft housing, a camshaft housing and/or an air intake.
